(19) United States
(12) Patent Application Publication
(10) Pub. No.: US 2018/0060483 A1
(43) Pub. Date: Mar. 1, 2018

(54) METHOD FOR PREDICTING THERAPEUTIC EFFICACY OF COMBINED DRUG BY MACHINE LEARNING ENSEMBLE MODEL

(71) Applicant: STANDIGM, Seoul (KR)

(72) Inventors: Sang Ok Song, Seoul (KR); Jinhan Kim, Seoul (KR); So Jeong Yun, Seoul (KR)

(21) Appl. No.: 15/458,093

(22) Filed: Mar. 14, 2017

(30) Foreign Application Priority Data
Aug. 23, 2016 (KR) 10-2016-0107130
Mar. 14, 2017 (KR) 10-2017-0031981

(51) Int. Cl. G06F 19/24; G06F 19/12; G06N 7/00

(52) U.S. Cl. CPC G06F 19/24; G06N 7/005; G06F 19/12

(57) ABSTRACT

A method of predicting therapeutic efficacy of a combined drug is provided. The method of predicting therapeutic efficacy of a combined drug can be useful in efficiently predicting therapeutic efficacy of the combined drug on cells by establishing and learning data through a computer using data on cells, data on individual drugs, and data on reaction between the cells and the individual drugs.

### CROSS-REFERENCE TO RELATED APPLICATION

This application claims priority to and the benefit of Korean Patent Application No. 10-2016-0107130 filed on Aug. 23, 2016 and Korean Patent Application No. 10-2017-0031981 filed on Mar. 14, 2017, the disclosure of which is incorporated herein by reference in its entirety.

### BACKGROUND

### 1. Field of the Invention

The present invention relates to a method of predicting therapeutic efficacy of a combined drug, and more particularly, to a method of predicting therapeutic efficacy of a novel combined drug capable of efficiently predicting the therapeutic efficacy of a drug combination for certain cells through rote learning based on data on cells, data on individual drugs, and data on reaction of the cells with the individual drugs.

### 2. Discussion of Related Art

In general, it costs hundreds of millions of dollars and takes several years to develop new drugs from the concept of preparation for sale. The finding of drugs starts by identifying a target affected by the drugs to find potential drugs affecting the target and determining which one of the potential drugs is safe and dependent on it. Sometimes, no suitable drugs are found, and one of drug candidates is modified in various ways of making it suitable.

A development process starts from a step of matching a molecule as a potential chemical with a target, for example, matching a protein with a human body or a microorganism. The matching of the molecule with the chemical is known to be as a drug lead which can induce the development of drugs. Then, the molecule is modified to be more actively, more selectively, and more pharmaceutically acceptable (for example, modified to reduce toxicity and be easily administered). These steps have a very high failure ratio.

Also, in many cases, there may be a number of drugs that can treat one disease. Finding which targets (and housekeeping proteins and/or other human proteins) are affected by which drug and how the targets interact with the drug can be useful in selecting one from alternative therapeutic methods, preventing side effects, preventing or controlling drug interaction, and/or selecting a therapeutic method for a rare disorder or disease, for example, when there is no correct drug to be selected for such a disease.

To induce a combination of such drugs, research has been conducted using various method in the prior art. However, there is no research on a method of predicting therapeutic efficacy of a combination of drugs through machine learning by associating each of the analysis of a cell line and the analysis of drugs and targets with an in vivo pathway map module.

### SUMMARY OF THE INVENTION

Therefore, the present invention is designed to solve the problems of the prior art, and it is an object of the present invention to provide a novel method of predicting therapeutic efficacy of a drug combination by deducing each of the analysis of a cell line and the analysis of a plurality of drugs and respective targets for the drugs with an in vivo pathway map module using computer learning.

It is another object of the present invention to provide a method of designing input features for rote learning to predict the therapeutic efficacy of a combined drug on a certain cell line.

It is still another object of the present invention to provide the establishment of a learning model for correlation between drugs and cells by deducing a gradient boosting classifier model.

According to an aspect of the present invention, there is provided a method of predicting therapeutic efficacy of a combined drug, which includes:

providing cell-related data;

providing drug-related data on each of drugs;

providing drug/cell correlation-related data on correlation between the drugs and the cells;

learning the cell-related data, the drug-related data, and the drug/cell correlation-related data using a computer algorithm; and

evaluating combined therapeutic efficacy of the drugs to be combined.

FIG. 1 shows a flowchart of a method of predicting therapeutic efficacy of a combined drug according to the present invention. As shown in FIG. 1, the method of predicting of therapeutic efficacy of a combined drug according to the present invention is characterized by including predicting the combined therapeutic efficacy of drugs using an ensemble of a plurality of gradient boosting classifier models as sequential ensemble learning.

The method of predicting therapeutic efficacy of a combined drug according to the present invention is characterized by including reflecting and adding confidence bounds predicted for result values predicted in each of models during the ensemble of the plurality of gradient boosting classifier models.

The method of predicting therapeutic efficacy of a combined drug according to the present invention includes a process of converting the gene-level data into pathway-level data. In this case, when the gene-level data are converted into the pathway-level data, matting deduction is applicable. The method of predicting therapeutic efficacy of a combined drug according to the present invention is characterized by including a first step of providing the cell-related data, the drug-related data and the drug/cell correlation-related data as the data at a gene level, and a second step of deducing data at a pathway level from the data at the gene level in the first step to provide the data at the pathway level.

In the method of predicting therapeutic efficacy of a combined drug according to the present invention, the providing of the cell-related data is characterized by including a first step of providing the gene-level data; and a second step of providing the pathway-level data deduced from the gene-level data.

In the providing of the cell-related data in the method of predicting therapeutic efficacy of a combined drug according to the present invention, the providing of the related data at the gene level is characterized by including providing mutation-related data, and intragenic copy number variation-related data.

FIG. 2 shows the mutation-related data provided at a gene level, and FIG. 3 shows the copy number variation data provided at a gene level. In the method of predicting therapeutic efficacy of a combined drug according to the present invention, a predicted value may be given by ‘1’ when the mutation-related data provided at the gene level include mutations, and the predicted value may be given by ‘0’ when the mutation-related data provided at the gene level include no mutations. In the method of predicting therapeutic efficacy of a combined drug according to the present invention, a predicted value may be given by ‘1’ when the copy number variation data provided at the gene level include a copy number>8, and the predicted value may be given by ‘0’ when the copy number variation data provided at the gene level include copy numbers other than 8.

In the method of predicting therapeutic efficacy of a combined drug according to the present invention, the providing of the cell-related data is characterized by including providing the data at the pathway level deduced from the data at the gene level. The method of predicting therapeutic efficacy of a combined drug according to the present invention includes a process of converting the gene-level data into pathway-level data. In this case, when the gene-level data are converted into the pathway-level data, matting deduction is applicable. For example, the cell-related data at the pathway level may be provided as figures in which mutant genes are included in respective pathways.

FIG. 4 shows the mutation-related data at a pathway level, and FIG. 5 shows the copy number variation data provided at a pathway level.

In the method of predicting therapeutic efficacy of a combined drug according to the present invention, Atlas of Cancer Signaling Network (ACSN) may be used for the data at the pathway level. The ACSN includes information on signaling mechanisms associated with cancer, and also includes five maps (apoptosis, cell cycle, DNA repair, cell survival, EMT, and cell motility) and 52 subdivided modules, all of which cover a basic cell signaling pathway. Information on each gene and information on each module are normalized under the HUGO names. The data at the gene level are converted into the form of map (or module)-based matrices by calculating the number of mutant genes in each map or module using the ACSN.

In the method of predicting therapeutic efficacy of a combined drug according to the present invention, the providing of the drug-related data is characterized by including providing the drug-related data on each of the plurality of drugs whose combined therapeutic efficacy is intended to be evaluated.

In the method of predicting therapeutic efficacy of a combined drug according to the present invention, the providing of the drug-related data is characterized by including a first step of providing the drug-related data at the gene level, and a second step of providing the drug-related data at the pathway level.

In the method of predicting therapeutic efficacy of a combined drug according to the present invention, the providing of the drug-related data at the gene level is characterized by including providing information on a target at a gene level. In the method of predicting therapeutic efficacy of a combined drug according to the present invention, the providing of the drug-related data at the gene level is characterized by including providing dose response curves for individual drugs, drug specificity scores, etc.

FIG. 6 shows data on drug targets provided at a gene level, and FIG. 7 shows data on the drug targets provided at a pathway level.

In the method of predicting therapeutic efficacy of a combined drug according to the present invention, the providing of the drug-related data at the pathway level is characterized by including providing mapping information and module information on a target at a pathway level.

In the method of predicting therapeutic efficacy of a combined drug according to the present invention, the providing of the drug/cell correlation-related data is characterized by including providing the drug/cell correlation-related data on each of the plurality of drugs whose combined therapeutic efficacy is intended to be evaluated.

In the method of predicting therapeutic efficacy of a combined drug according to the present invention, the providing of the drug/cell correlation-related data is characterized by including a first step of providing the related data at the gene level; and a second step of providing the drug/cell correlation-related data at the pathway level deduced from the related data at the gene level.

In the method of predicting therapeutic efficacy of a combined drug according to the present invention, the related data at the gene level on the correlation between the drugs and the cells are characterized by including drug target-related data, dose-related data, drug response-related parameters, etc., particularly, including a half-maximal inhibitory concentration (IC₅₀), a slope of the dose-response curve fitted (H), and maximum cells killed percentage (E_inf) data.

In the method of predicting therapeutic efficacy of a combined drug according to the present invention, learning of the cell-related data, the drug-related data and the drug/cell correlation-related data using the computer algorithm is characterized by using an ensemble model exhibiting the best cross-validation performance using a number of classifier models consisting of a combination of different feature data and a combination of different learning parameters.

The method of predicting therapeutic efficacy of a combined drug according to the present invention is characterized by reflecting and adding confidence bounds predicted for result values predicted in each of models during the ensemble of the plurality of gradient boosting classifier models.

In the method of predicting therapeutic efficacy of a combined drug according to the present invention, predicting and evaluating the cell-related data, the drug-related data and the drug/cell correlation-related data using the computer algorithm is characterized by being performed by calculating probabilities of classifier models which predict the combined drug to have a synergic effect and probabilities f classifier models which predict the combined drug to have no synergic effect.

The method of predicting therapeutic efficacy of a combined drug according to the present invention is characterized by including predicting the combined therapeutic efficacy of the drugs to maximize cross-validation performance using an ensemble of the n (n>1) gradient boosting classifier models as sequential ensemble learning. FIG. 13 shows a probability prediction model based on an ensemble model.

In the method of predicting therapeutic efficacy of a combined drug according to the present invention, establishing a learning model for the cell-related data, the drug-related data and the correlation between the drugs and the cells using the computer algorithm is characterized by including deducing n (n>1) gradient boosting classifier models consisting of a combination of different feature data and a combination of different learning parameters. In the method of predicting therapeutic efficacy of a combined drug according to the present invention, the gradient boosting classifier model may use Scikit-learn software. In the method of predicting therapeutic efficacy of a combined drug according to the present invention, each model forming an ensemble exhibits different prediction performances, depending on the constructed data and learning parameters used.

In the method of predicting therapeutic efficacy of a combined drug according to the present invention, the predicting and evaluating of the combined therapeutic efficacy of the drugs to be combined is characterized by being performed by calculating probabilities (P_S) of classifier models which predict the combined drug to have a synergic effect and probabilities (P_N) of classifier models which predict the combined drug to have no synergic effect.

The method of predicting therapeutic efficacy of a combined drug according to the present invention may further include verifying the prediction results by changing an input order of the combined drugs to prevent the prediction results from being changed according to the order of drug combinations when synergic effects are expected according to the drug combinations.

The method of predicting therapeutic efficacy of a combined drug according to the present invention can be useful in increasing a precision value using a class-weighting technique to solve problems such as class distribution imbalance, which distinguishes between the presence and absence of the synergic effect of the combined drug.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic diagram showing a method of predicting therapeutic efficacy of a combined drug according to the present invention;

FIGS. 2 to 8 are diagrams showing input data for machine learning:

FIG. 2 shows a mutation matrix at a gene level;

FIG. 3 shows a copy number variation matrix at a gene level;

FIG. 4 shows a drug target matrix at a gene level;

FIG. 5 shows a mutation matrix at a pathway level;

FIG. 6 shows a copy number variation matrix at a pathway level;

FIG. 7 shows a drug target matrix at a pathway level; and

FIG. 8 shows a correlation matrix between drugs and cells;

FIG. 9 shows input features used for ensemble learning of a gradient boosting classifier model in the method of predicting therapeutic efficacy of a combined drug according to the present invention;

FIG. 10 shows that gradient boosting classifier models which form an entire ensemble model have different performance supplementation patterns according to the learning parameters in the method of predicting therapeutic efficacy of a combined drug according to the present invention;

FIG. 11 shows a method of preventing predicted results from being changed according to the order of drug combinations upon prediction of synergic effects of drugs in the method of predicting therapeutic efficacy of a combined drug according to the present invention;

FIG. 12 shows an increase in precision value using a class-weighting technique to solve problems such as class distribution imbalance, which distinguishes between the presence and absence of the synergic effect of the combined drug, in the method of predicting therapeutic efficacy of a combined drug according to the present invention;

FIG. 13 shows that an ensemble is formed using probability values obtained through the prediction rather than values themselves predicted in each model when the ensemble is formed in the ensemble model according to one exemplary embodiment of the present invention;

FIG. 14 shows synergic result values and consequential confidence values which are predicted by the ensemble model when predicted in each of the models forming the ensemble model in the method of predicting therapeutic efficacy of a combined drug according to the present invention;

FIG. 15 shows the entire performance of the ensemble model according to one exemplary embodiment of the present invention; and

FIG. 16 shows types of cell lines having high prediction precision in the ensemble model according to one exemplary embodiment of the present invention.

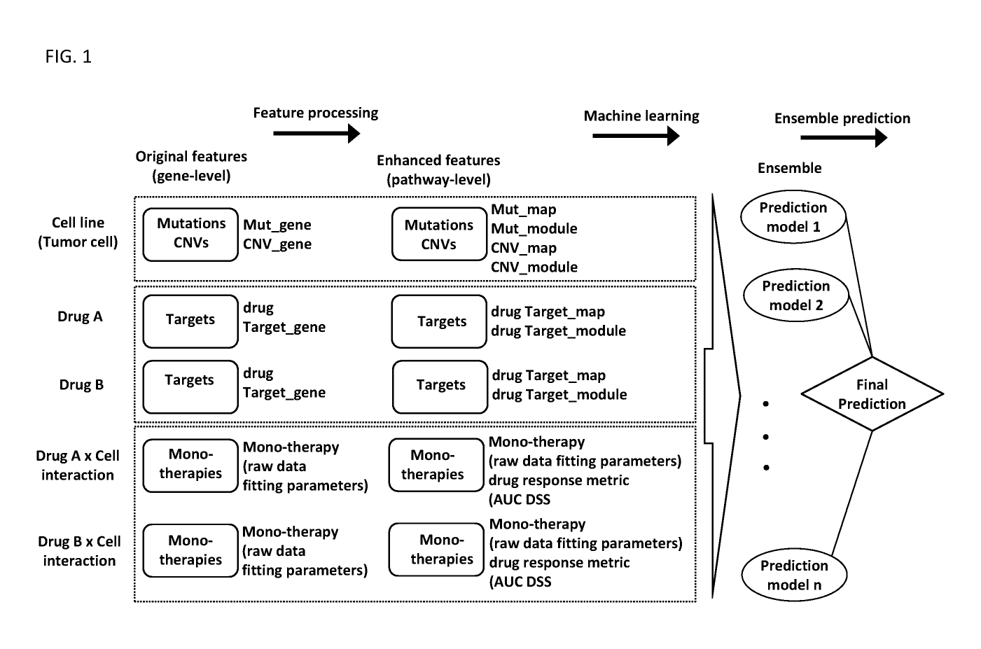

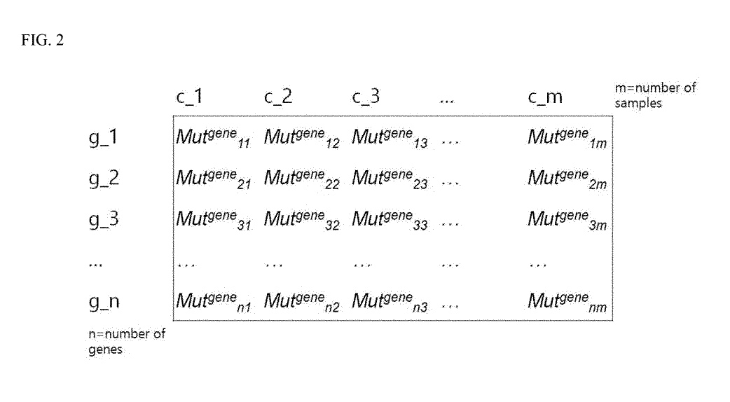

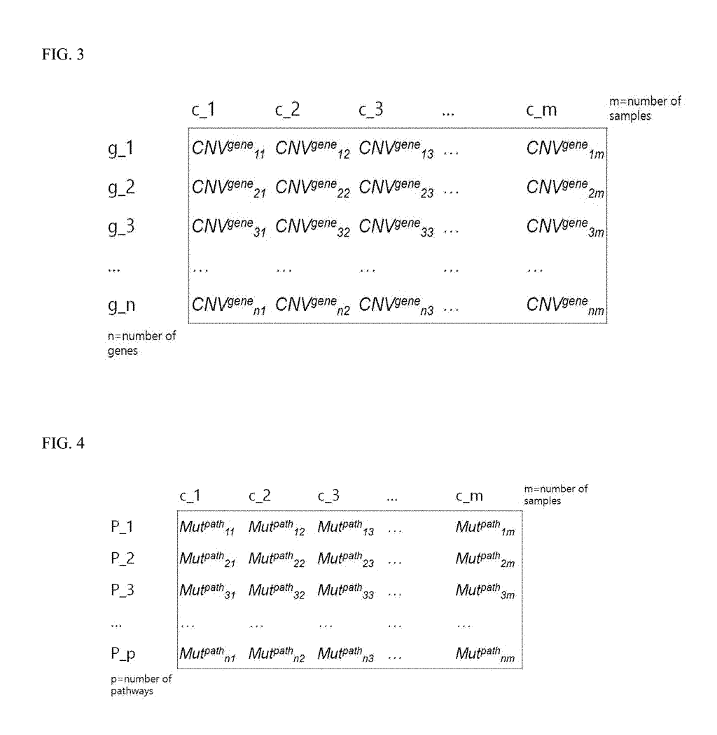

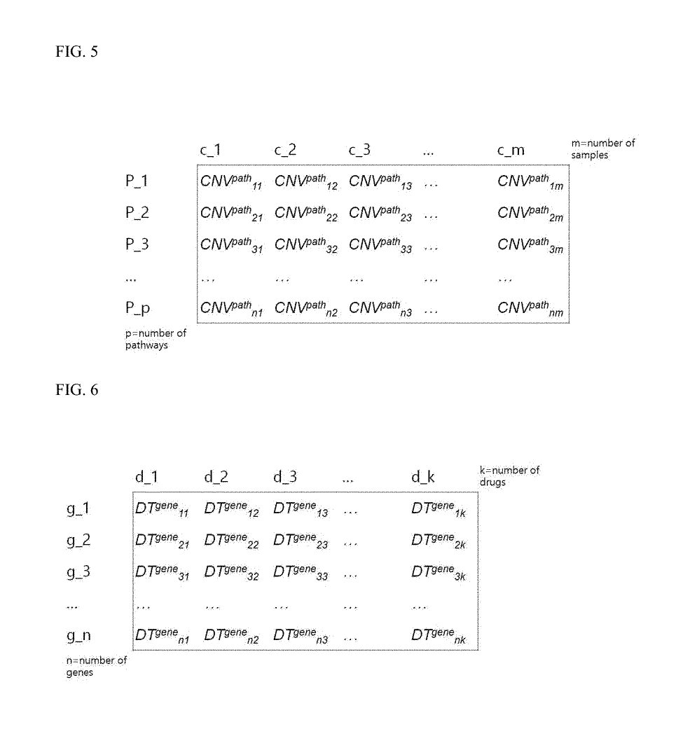

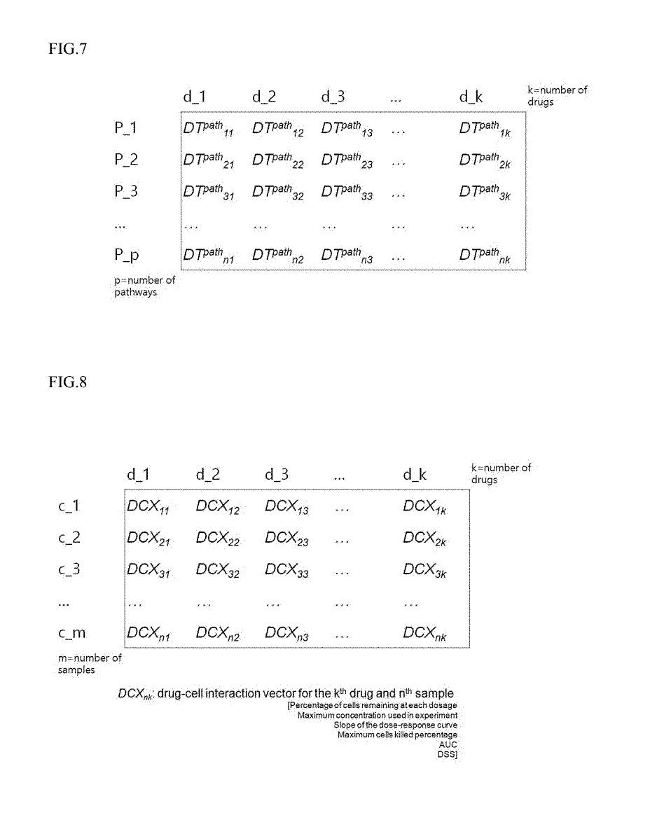

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the scope of the invention.

Unless specifically stated otherwise, all the technical and scientific terms used in this specification have the same meanings as what are generally understood by a person skilled in the related art to which the present invention belongs. In general, the nomenclatures used in this specification and the experimental methods described below are widely known and generally used in the related art.

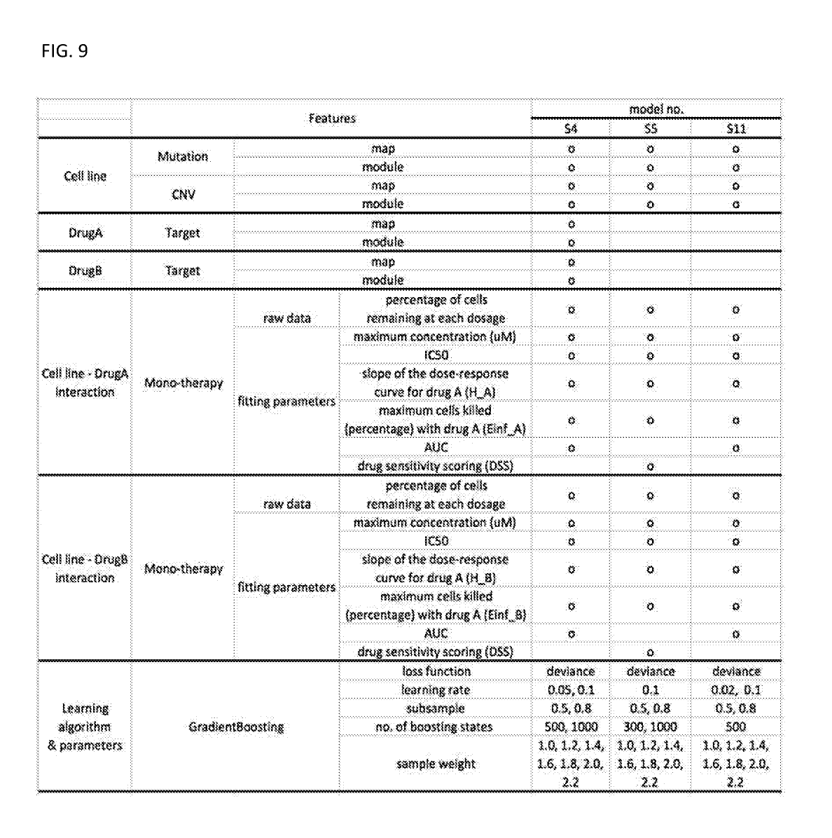

According to one exemplary embodiment of a method of predicting therapeutic efficacy of a combined drug according to the present invention, three models were established. The test results in each of the models are shown in FIG. 9.

In method of predicting therapeutic efficacy of a combined drug according to the present invention, each of the models forming an ensemble exhibits different prediction performances, depending on the constructed data and learning parameters used. For each of the three models S4, S5 and S11, different combinations were made using data sets, types of loss functions as learning parameters, leaning rates, data sampling ratios, the number of trees forming gradient boosting, and class weights to be learned.

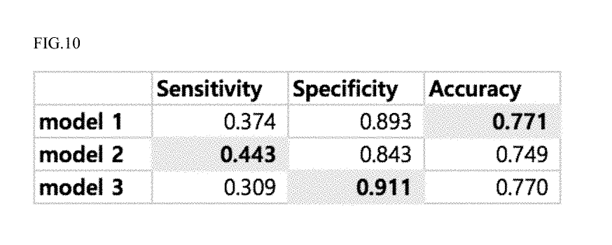

FIG. 10 shows performance features in each of models by comparing predicted values to correct values. As shown in FIG. 10, it can be seen that the models exhibiting different performance features were used to determine the optimum predicted values complementarily due to an ensemble effect.

FIG. 11 shows a method of preventing predicted results from being changed according to the order of drug combinations when synergic effects of drugs are predicted according to the drug combinations in one embodiment of the method of predicting therapeutic efficacy of a combined drug according to the present invention.

In the method of predicting therapeutic efficacy of a combined drug according to the present invention, the machine learning is divided into learning data and test data for the purpose of prediction. In a prediction test, correct prediction is achieved even when a data format of the test data is identical to that of the learning data. For example, when a position of information is changed, an unwonted test may be carried out as the information whose position is changed is used instead of the original information.

The method of predicting therapeutic efficacy of a combined drug according to the present invention includes learning a plurality of drugs, but has a problem in that positions of the drugs may be changed during a test. Therefore, the reliability of the results may be improved by performing learning on the plurality of drugs in duplicate by changing positions of types of information on the drugs during machine learning in the present invention.

In the method of predicting therapeutic efficacy of a combined drug according to the present invention, there is generally an imbalance in the number of cases in which the presence and absence of the synergic effect in the learning data are present as correct answers. This is because there are absolutely few cases in which the drugs are effective in biological problems.

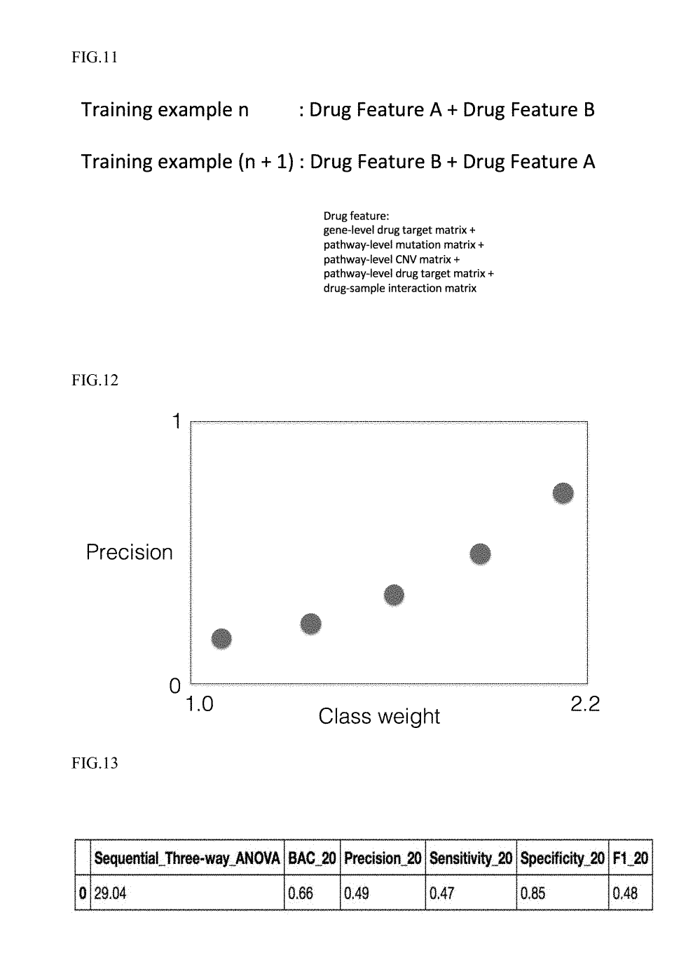

FIG. 12 shows a method of solving a problem regarding the class imbalance according to the present invention. The method of predicting therapeutic efficacy of a combined drug according to the present invention is characterized by finding an optimum range of performance while changing the class weights to supplement such a class imbalance. As shown in FIG. 12, the class weights were applied from a basic weight of 1.0 to the peak weight of 2.2 at a change unit of 0.2. At the peak weight, the recall performance is not degraded below the base line

In the method of predicting therapeutic efficacy of a combined drug according to the present invention, six evaluation indexes were made to evaluate the prediction performance of synergy values of the drug combinations in an algorithm, as shown in FIG. 13. The results of measuring the performance evaluation results for the evaluation indexes are shown in FIG. 13.

1. Sequential three way ANOVA: scoreglobal=−sgn×log 10(p)
sgn: sign of the effect size,
p: p-value for F-statistic

2. BAC_20=(Sensitivity+Specificity)/2

3. Precision_20=TP/(TP+FP)

4. Sensitivity_20=TP/(TP+FN)

5. Specificity_20=TN/(TN+FP)

6. F1_20=2 TP/(2TP+FP+FN)

Note: TP: True Positive, TN: True Negative, FP: False Positive, and FN: False Negative

When a confusion matrix was constructed to calculate BAC, precision, sensitivity, specificity, and F1 values, the cut-off value for the presence or absence of the synergy values was set as 20.

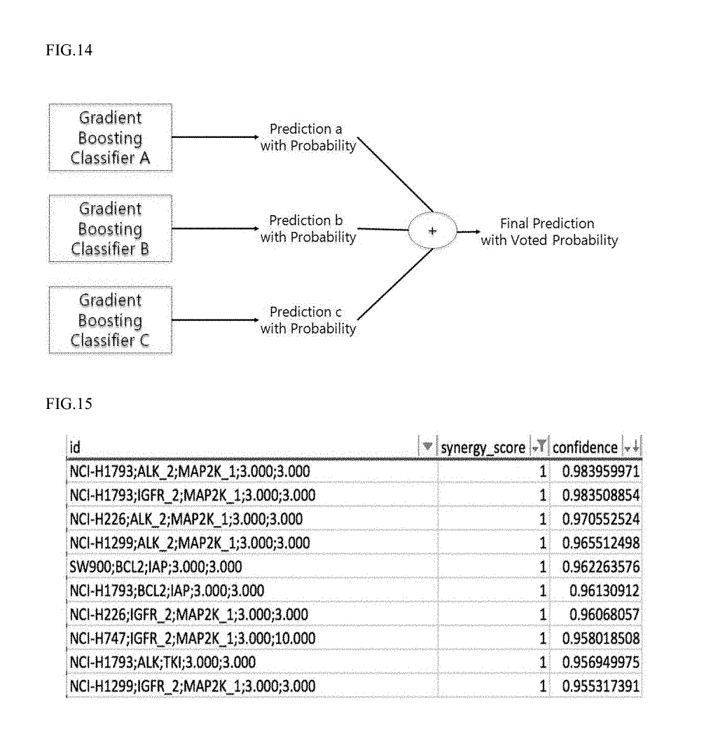

In the method of predicting therapeutic efficacy of a combined drug according to the present invention, when an ensemble is formed using the result values predicted in each of gradient boosting models forming the ensemble, that is, using the presence and absence of the synergic effect, the presence and absence of the synergic effect are not simply summed up, but predicted confidence bounds of the presence and absence of the synergic effect in each model are applied to be summed up, as shown in FIG. 14, thereby further improving the prediction performance by the ensemble.

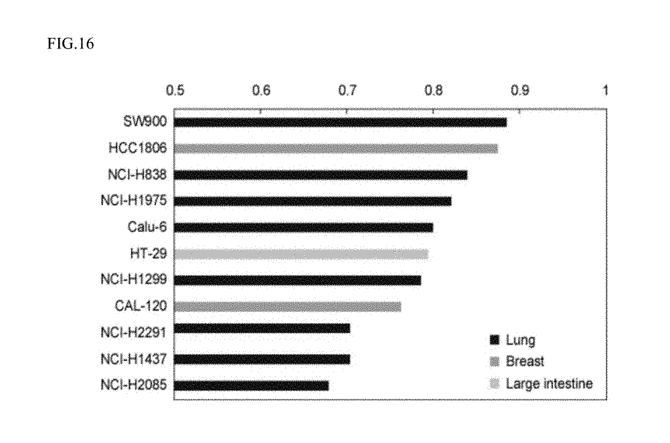

FIG. 15 shows synergy values (synergy_score) and confidence values according to the drug combination (id) predicted using the developed algorithm in the method of predicting therapeutic efficacy of a combined drug according to the present invention.

The drug combinations and concentrations thereof with which certain cells were treated are shown in in the id of FIG. 15.

(Case) NCI-H747;IGFR_2;MAP2K_1;3.000;10.000

NCI-H1793: cell type, IGFR_2: drug1 name, MAP2K_1: drug2 name, 3.000: peak concentration (uM) of drug 1, 10.000: peak concentration (uM) of drug2

FIG. 15 shows that the synergy_score is indicated by ‘1’ or ‘0’ using certain cut-off values for the presence and absence of the synergy values of the combinations.

In the method of predicting therapeutic efficacy of a combined drug according to the present invention, the presence and absence of the synergic effects through gradient boosting depends on the confidence values. The presence and absence of the synergic effects are determined by applying the cut-off values to the confidence bounds. In FIG. 15, the confidence value refers to an output value in the gradient boosting model, that is, a probability value determining whether or not the drug combinations have a synergic effect.

FIG. 16 shows results of analyzing whether the method of predicting therapeutic efficacy of combined drug according to the present invention has a strong point in predicting the combined therapeutic efficacy against a certain cell line using the developed algorithm, and whether the method easily predicts the combined therapeutic efficacy in which cell line if so.

A confusion matrix between correct answers and predicted results provided based on the certain cut-off values for a total of 85 cell lines were generated. The accuracies and accuracy p-values of the predicted results for respective cell lines were calculated using such a confusion matrix. As a result, it was revealed that the accuracy p-value was less than 0.1 in 11 of the 85 cell lines.

Therefore, the present inventors have judged that the prediction method according to the present invention has a significant strong point for the 11 corresponding cell lines, and identified site primary and histology of each of the cell lines. Then, the 11 cell lines whose accuracy p-value was less than 0.1 were aligned according to the accuracy. As a result, the bar graph in which organs are indicated by different colors is shown in FIG. 16. As shown in FIG. 16, it can be seen that the 11 cell lines consisted of 8 lung carcinoma cell lines, two breast carcinoma cell lines, and one large intestine carcinoma cell line.

The method of predicting therapeutic efficacy of a combined drug according to the present invention can be useful in efficiently predicting therapeutic efficacy of the combined drug on certain cells by establishing and learning data for designing input features for rote learning so as to predict the therapeutic efficacy of the combined drug on a certain cell line using a computer and data on cells, data on individual drugs, and data on reaction between the cells and the individual drugs.

Accordingly, the method of predicting therapeutic efficacy of a combined drug according to the present invention is applicable to a new-drug development process by choosing a drug combination having a high probability.

It will be apparent to those skilled in the art that various modifications can be made to the above-described exemplary embodiments of the present invention without departing from the scope of the invention. Thus, it is intended that the present invention covers all such modifications provided they come within the scope of the appended claims and their equivalents.

What is claimed is:

1. A method of predicting therapeutic efficacy of a combined drug, comprising:
providing cell-related data;
providing drug-related data on a plurality of drugs to be combined;
providing drug/cell correlation-related data on correlation between the drugs and the cells;
learning the cell-related data, the drug-related data, and the drug/cell correlation-related data using a computer algorithm; and
evaluating combined therapeutic efficacy of the drugs to be combined.

2. The method of claim 1, wherein the providing of the cell-related data comprises:
a first step of providing gene-level data; and
a second step of providing pathway-level data deduced from the gene-level data.

3. The method of claim 2, wherein the gene-level data comprises mutation-related data, or intragenic copy number variation-related data.

4. The method of claim 1, wherein the providing of the drug-related data on the plurality of drugs comprises:
providing the drug-related data on each of the plurality of drugs whose combined therapeutic efficacy is intended to be evaluated.

5. The method of claim 1, wherein the providing of the drug-related data on the plurality of drugs comprises:
extracting the drug-related data at a pathway level from the drug-related data at a gene level.

6. The method of claim 5, wherein the drug-related data at the gene level provided in the providing of the drug-related data provide information on a [symbol] target at a gene level.

7. The method of claim 5, wherein the drug-related data at the pathway level deduced from the drug-related data at the gene level provide mapping information and module information on a target at a pathway level.

8. The method of claim 1, wherein the providing of the drug/cell correlation-related data comprises:
providing the drug/cell correlation-related data on each of the plurality of drugs whose combined therapeutic efficacy is intended to be evaluated.

9. The method of claim 1, wherein the providing of the drug/cell correlation-related data comprises:
mapping feature data at a pathway level from the data on the correlation between the individual drugs and the cells at a gene level.

10. The method of claim 8, wherein the data on the correlation between the individual drugs and the cells at the gene level comprise drug target-related data, dose-related data, and drug response-related parameters.

11. The method of claim 1, wherein establishing a learning model for the cell-related data, the drug-related data and the correlation between the drugs and the cells using the computer algorithm comprises deducing n (n>1) gradient boosting classifier models consisting of a combination of different feature data and a combination of different learning parameters.

12. The method of claim 11, wherein the establishing of the learning model for the cell-related data, the drug-related data and the correlation between the drugs and the cells using the computer algorithm comprises predicting the combined therapeutic efficacy of the drugs to maximize cross-validation performance using an ensemble of then (n>1) gradient boosting classifier models.

13. The method of claim 11, wherein predicting and evaluating the combined therapeutic efficacy of the drugs to be combined is performed by calculating probabilities (P_S) of classifier models which predict the combined drug to have a synergic effect and probabilities (P_N) of classifier models which predict the combined drug to have no synergic effect.
